(19) United States
(12) Patent Application Publication
(10) Pub. No.: US 2026/0202917 A1
(43) Pub. Date: Jul. 16, 2026

(54) Wearable Device for Anatomically Congruent Sensory Feedback in Extended Reality Environments

(71) Applicant: University of Utah Research Foundation, Salt Lake City, UT (US)

(72) Inventor: Jacob A GEORGE, Salt Lake City, UT (US)

(21) Appl. No.: 19/139,317

(22) PCT Filed: Dec. 15, 2023
(86) PCT No.: PCT/US2023/084467

§ 371 Date: Jun. 13, 2025

Related U.S. Application Data
(60) Provisional application No. 63/433,141, filed on Dec. 16, 2022.

(51) Int. Cl. G06F 3/01

(52) U.S. Cl. CPC G06F 3/016; G06F 3/015

(57) ABSTRACT

A wearable device for providing sensory feedback in an extended reality environment is disclosed. The device includes a band configured to enclose an anatomical location, such as a wrist, adjacent to a distal extremity, such as a hand. The band houses a plurality of electrodes that deliver transcutaneous electrical nerve stimulation (TENS) to the distal extremity, eliciting distally referred sensations corresponding to the user's interaction with a digital object. A controller receives sensor signals indicative of movement of the distal extremity, determines the user's motor intent, and generates a sensory feedback signal to control the delivery of TENS pulses. The device allows for anatomically congruent sensory feedback in augmented reality environments without inhibiting natural interactions with physical objects.

### CROSS-REFERENCE TO RELATED APPLICATIONS

This application claims the benefit of and priority to U.S. Provisional Application No. 63/433,141, filed Dec. 16, 2022, and titled “Device for Neural Stimulation,” the entirety of which is incorporated herein by this reference.

### BACKGROUND

Extended reality technologies, including augmented reality (AR) and virtual reality (VR), aim to create immersive digital experiences for users. These technologies have found applications in various domains, including gaming, education, healthcare, and remote work. In these environments, users interact with digital objects through various input devices such as handheld controllers, gloves, or motion tracking systems.

One of the primary challenges in such extended reality environments is the provision of realistic sensory feedback. In the physical world, interactions with objects involve a complex interplay of motor control and sensory feedback. For instance, when a person picks up an object, they not just see and manipulate the object, but also feel it. However, in extended reality environments, interactions are often limited to visual and auditory experiences. While some systems provide rudimentary haptic feedback, such as vibrations, these are not capable of replicating the rich, multidimensional sensations experienced in the physical world. More advanced haptic interfaces have been explored, but these often involve bulky and cumbersome devices such as gloves or exoskeletons, which can encumber natural hand movements, limit the user's dexterity, and impede interactions with real objects.

Accordingly, there is an ongoing need for devices capable of providing effective sensory feedback within an extended reality environment without encumbering the user.

### SUMMARY

Disclosed herein is a wearable device configured to provide distally referred sensory feedback based on the user's interaction with a digital object within an extended reality environment.

In one embodiment, the wearable device includes a band configured to at least partially enclose an anatomical location adjacent to a distal extremity. The band includes an inner surface and a plurality of electrodes disposed on the inner surface. The electrodes are disposed so as to contact a skin surface of the anatomical location when the wearable band is positioned thereon. The electrodes are configured to deliver transcutaneous electrical nerve stimulation (TENS) to the skin, muscles or nerves adjacent to or innervating the distal extremity. The wearable device also includes a controller configured to receive sensor signals indicative of movement of the distal extremity, determine a motor intent of the user with respect to a digital object within the extended reality environment, and generate a sensory feedback signal to control delivery of TENS pulses through a subset of the plurality of electrodes, thereby eliciting distally referred sensations at the distal extremity and away from the band. The distally referred sensations correspond to the user's interaction with the digital object.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the disclosure will become apparent and more readily appreciated from the following description, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates an example wearable device configured to be worn around the wrist of a user.

FIG. 2 illustrates a schematic view of the example wearable device, showing the electrodes, controller, and other components.

FIG. 3 illustrates an example operation of the motor intent classifier of the controller.

FIG. 4 is an example of a just noticeable difference (JND) plot relating intensity discrimination to changes in pulse frequency.

FIG. 5 illustrates an example from one user showing different localized sensations corresponding to activation of electrodes at different wrist locations.

FIG. 6 is an example showing how wrist flexion can change the perceived intensity of sensory feedback and can slightly affect perceived location of the sensation.

FIG. 7 illustrates an example amplitude correction and an electrode placement correction that can be implemented to maintain a substantially consistent sensation at different levels of wrist flexion.

### DETAILED DESCRIPTION

### I. Overview of Example Device

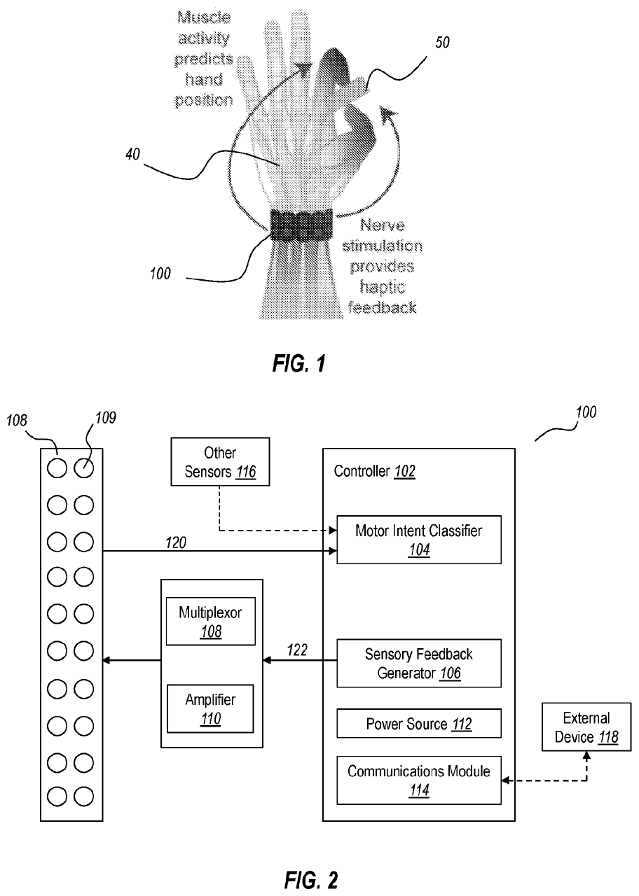

FIG. 1 illustrates an example wearable device 100 configured to be worn around the wrist of a user. As described in more detail below, as the user's hand 40 interacts with a digital object 50 within an extended reality environment, measured muscle activity (e.g., via electromyography (EMG)) can be utilized to determine the user's motor intent, including the intended movement of the user's hand and fingers with respect to the digital object 50. Based on the determined motor intent, the wearable device 100 generates a sensory feedback signal that controls delivery of transcutaneous electrical nerve stimulation (TENS) pulses to the wrist. The TENS pulses are directed to sensory nerves that innervate the hand, and thereby elicit distally referred sensations that the user feels at the fingers rather than at the wrist. That is, the TENS pulses are configured to generate distally referred sensations that correspond to and are anatomically congruent with the user's interaction with the digital object.

The digital object 50 within the extended reality environment can take various forms, such as a virtual tool, virtual control, virtual object for manipulation, or digital information overlay.

In some cases, the TENS pulses stimulate the median, ulnar, and radial nerves at the wrist of the user. This allows for the elicitation of distally referred sensations at specific digits or subset of digits on the hand. The device can thereby create a sensation that is anatomically congruent with the user's interaction with the digital object, enhancing the user's immersive experience within the extended reality environment.

The wearable device 100 beneficially provides an interface for an extended reality environment that enables control and sensory feedback while keeping the user's hand 40 unencumbered to allow physical interactions with real objects. For example, the wearable device 100 can enable both control of a digital hand and sensory feedback to the real hand that corresponds to the user's activity within the extended reality environment, without requiring the placement of hardware on the fingers or other parts of the hand. The wearable device 100 also beneficially provides distally referred sensations away from the wearable device 100 itself, enabling realistic sensory feedback rather than relying on off-target sensations such as evoking them at the wrist.

Although most of the examples described herein relate to a wearable device 100 designed to be worn around the wrist, and designed to provide sensory feedback to a user's hand, the same principles and features may be applied to other anatomical locations, such as by placing a wearable device around the ankle to control sensory feedback to the user's foot, placing a wearable device around the upper arm to control sensory feedback to a more distal portion of the user's arm, or any other suitable anatomical location where sufficient electrical contact can be made with underlying nerves in order to direct TENS pulses to elicit referred sensations at more distal locations.

As used herein, a “distal extremity” refers to any body part, such as the arms and legs, that extends distally from the center/trunk of the body. As used herein, “an anatomical location adjacent to a distal extremity” refers to a location at which the wearable device can be positioned to provide stimulation of nerves that innervate the distal extremity. For example, when the distal extremity is a hand, the adjacent anatomical location can be the wrist, and when the distal extremity is a foot, the adjacent anatomical location can be the ankle.

FIG. 2 illustrates a schematic view of the example wearable device 100, showing an inner surface of a band 108 configured to at least partially enclose an anatomical location (e.g., the wrist) adjacent to a distal extremity. A plurality of electrodes 109 are disposed on the band 108 and project out from the inner surface so that they are contacted against the user's skin when the band 108 is worn.

The wearable device 100 also includes a controller 102 that includes a motor intent classifier 104, a sensory feedback generator 106, a power source 112, and a communications module 114. The communications module 114 enables communication with one or more external devices 118, such as through wired and/or wireless connections. The communications module 114 can support, for example, various wireless communication protocols, such as Bluetooth, Wi-Fi, or near-field communication (NFC). The communications module 114 can also support secure data transmission protocols to ensure the privacy and security of the user's data.

In some embodiments, some or all of the processing functions of the controller 102 may be carried out by the one or more external devices 118 rather than within the controller 102 itself. The external device 118 may also be utilized to send instructions to the controller 102, to receive and display data from the controller 102, and the like. In some embodiments, the one or more external devices 118 can include devices that are part of an extended reality system, such as display devices configured to display an extended reality environment to the user.

The motor intent classifier 104 is configured to receive sensor signals indicative of movement of the distal extremity and determine, based on the received sensor signals, a motor intent of the user with respect to a digital object within the extended reality environment. The sensor signals can include EMG signals from the band 108, as indicated by arrow 120. For example, the plurality of electrodes 109 or a subset thereof can be configured for EMG sensing. Additionally, or alternatively, the sensor signals can include data from other sensors 116, such as motion capture imaging sensors or other motion sensors. The functionality of the motion intent classifier 104 is described in more detail below.

The controller 102 also includes a sensory feedback generator 106 configured to generate, based on the determined motor intent, a sensory feedback signal 122 to control delivery of TENS pulses through a subset of the electrodes 109, thereby eliciting distally referred sensations at the distal extremity and away from the band. As shown, the sensory feedback signal 122 can be directed to an amplifier 110 and/or multiplexor 108 to modulate delivery of the TENS pulses to the selected electrodes 109.

The amplifier 110 can be used to ensure sufficient compliance voltage to pass current through the skin. In some embodiments, for example, a current source (not shown) is powered by the amplifier 110 which is in turn powered by the power source 112. In current-controlled embodiments, the device 100 preferably includes a single current source, for greater space, cost, and power efficiencies. The multiplexor 108 can function in conjunction with the current source to vary the subsets of electrodes 109 and thereby vary localization of the generated sensory feedback. For example, the multiplexor 108 can function to select a subset of the electrodes 109 to serve as the cathode, anode, and ground. As described in more detail below, the subset of electrodes 109 may be selected to “steer” and control localization of the sensory feedback.

The TENS pulses are preferably biphasic. The stimulation current provided by the device may be in a range of about 1 mA to about 20 mA, though this range may vary depending on particular application preferences.

The band 108 may take any suitable form that allows positioning at least partially around the intended anatomy and provides sufficient contact of the electrodes 109 against the user's skin. The band 108 can include any suitable material that enables wearing of the device and appropriately integrates the electrodes 109 and other components of the device 100. The band 108 can be in the form of a bracelet or wristwatch, for example, providing a comfortable and convenient form factor for the user.

The sizes, construction, placement/spacing, and number of electrodes 109 can vary according to application needs. Smaller electrodes may be favored for certain wearable form factors, but smaller electrodes also increase resistance, thus requiring higher compliance voltages and more complicated amplification circuitry. Example electrodes that balance these demands may range in size from 5 mm to 13 mm, but may be larger or smaller for certain applications. The electrodes 109 need not be the same size.

The electrodes 109 can have any suitable construction known in the art. Presently preferred embodiments include electrodes 109 that are re-usable and beneficial in long-term applications, such as dry electrodes and/or re-usable adhesive electrodes (e.g., pre-gelled electrodes). Dry electrodes may include one or more metals or alloys such as stainless steel, gold, and/or silver, polymer composites, carbon, and/or conductive textile components.

In most applications, a greater number of electrodes can provide greater granularity of sensory feedback. In some cases, at least 8 electrodes are preferred, though a greater number of electrodes (e.g., 10, 12, 16, 24, 32, or more) may be utilized according to particular application preferences.

### II. Determination of Motor Intent

Based on the received sensor signals (e.g., EMG signals and/or motion capture data) the motor intent classifier 104 determines the motor intent of the user with respect to a digital object within the extended reality environment. The motor intent classifier can be trained to classify distal extremity action and to regress action progression. This allows the controller 102 to determine the user's intended interaction with the digital object, such as grasping, touching, or manipulating the object.

The motor intent classifier 104 can incorporate a computational model trained to discern and categorize the user's intended movements or actions with respect to a digital object within the extended reality environment. For example, the motor intent classifier 104 can be configured to classify patterns indicative of specific actions by the distal extremity. These actions can then be analyzed to estimate their progression. Real-time operation of the motor intent classifier 104 ensures that the generated sensory feedback is accurate and enhances the immersive experience within the extended reality environment.

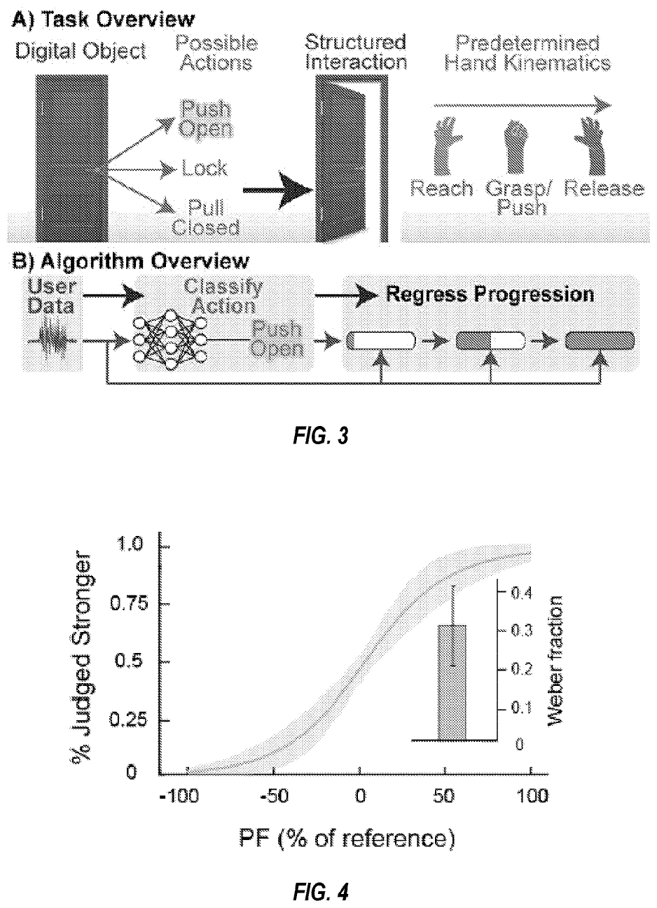

FIG. 3 illustrates an example operation of the motor intent classifier 104. A digital object (a door, in this example) is associated with a predefined list of possible actions (push open, lock, pull closed) in response to user interaction. A sequential series of predetermined hand actions are associated with each digital object action. In this example, the sequential predetermined hand actions of reach, grasp/push, then release are associated with the action of pushing open the door. The motor intent classifier 104 can function to classify the intended interaction with the digital object based on the received sensor signals (EMG user data, in this example), and then determine progression through the associated sequence of predetermined hand actions.

The motor intent classifier 104 can be trained by tasking the user, or multiple users, to mimic a variety of predefined interactions with digital objects while recording EMG and/or using image capture. The synchronized hand actions and sensor data can train a neural network, such as a convolutional neural network to classify the hand actions and digital object interactions. A recursive Bayesian filter, such as a Kalman filter, can be trained to regress action progression.

Other machine learning techniques may additionally or alternatively be utilized to train the motor intent classifier 104. For example, other neural networks such as recurrent neural networks (RNNs), capsule networks (CapsNets), and/or Siamese networks may be utilized to classify hand actions and digital object interactions. Moreover, other filter techniques such as using a particle filter, extended Kalman filter, unscented Kalman filter, complementary filter, and/or a moving horizon estimation (MHE) can be utilized to regress action progression.

### III. Generation of Sensory Feedback

Once the motor intent of the user is determined, the controller 102 generates a sensory feedback signal 122. This sensory feedback signal 122 controls the delivery of TENS pulses through a subset of the plurality of electrodes 109. The controlled delivery of TENS pulses elicits distally referred sensations at the distal extremity, providing the user with sensory feedback that corresponds to their interaction with the digital object. In some instances, the TENS pulses are configured to elicit distally referred sensations at a specific digit or subset of digits. This allows for more precise and targeted sensory feedback, enhancing the user's ability to interact with the digital object in a more intuitive and natural manner.

### A. Magnitude Modulation

The controller 102 of the wearable device is capable of modulating the sensory feedback signal 122 to vary the intensity of the perceived sensation. This is achieved by adjusting the TENS pulse parameters, such as one or more of pulse width, pulse amplitude, or pulse frequency. By fine-tuning these parameters, the device can deliver a range of sensory feedback, from subtle to strong, thereby providing the user with a nuanced perception of tactile stimuli that corresponds to their interactions within the extended reality environment.

Different tactile magnitudes can be determined using psychometric evaluations, and testing thus far has demonstrated that up to 184 different tactile magnitudes can be conveyed to the user. For example, the just-noticeable difference (JND) can be quantified for changes in pulse width, pulse amplitude, and pulse frequency. FIG. 4 is an example of a JND plot relating intensity discrimination to changes in pulse frequency. The inset shows the Weber fraction (a metric that normalizes the JND to the stimulus).

### B. Localization Control

The wearable device is also able to localize sensory feedback (e.g., to specific digits or subsets of digits). This functionality can be facilitated by the multiplexor 108, which selects and assigns specific electrodes as cathode, anode, and ground based on the intended sensory feedback to elicit. The selected subset of electrodes 109 determines the direction of the current flow to the user, which in turn influences the location and intensity of the distally referred sensations elicited by the TENS pulses. The delivery of TENS pulses thus enables the elicitation of sensations at precise anatomical locations on the distal extremity, such as individual digits or subsets of digits, enhancing the user's ability to perform tasks requiring fine motor control and to interact with digital objects in a more intuitive manner.

By dynamically selecting the subset of electrodes 109, the controller 102 can provide anatomically congruent sensory feedback to the user that updates in real time (i.e., updates fast enough to avoid noticeable lag). This dynamic localization process enables distally referred sensations that accurately correspond to the user's interaction with the digital object, thereby enhancing the user's immersive experience within the extended reality environment.

Localization control can be implemented by orienting aligning the band 108 in a predefined manner with respect to one or more anatomical landmarks on the user, such as the ulna and pisiform. This enables substantially similar electrode orientation with respect to the target nerves (e.g., ulnar, radial, and median nerves) across different users. Due to substantial similarities across users in the location of these nerves, similar localization results can be expected across different users. Moreover, customized settings can be implemented for an individual user as needed to fine-tune the mapping between electrode subsets and resulting sensory location.

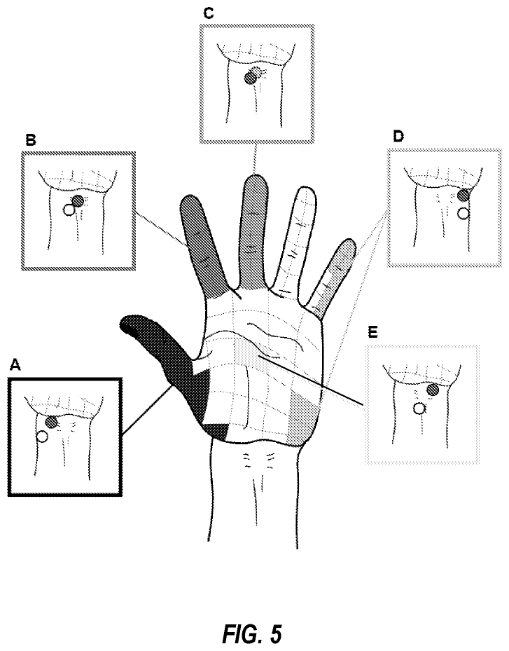

FIG. 5 illustrates an example from one user showing different localized sensations corresponding to activation of electrodes at different wrist locations. Activation of different subsets of the electrodes 109 can thus generate different localized sensations for the user.

The multiplexor 108 can rapidly “steer” the TENS pulses across different subsets to elicit rich and complex sensory feedback. For example, to elicit a sensation of pinching a small object between the thumb and index finger, the multiplexor 108 can alternate between causing sensations at the thumb and at the index finger. The multi-channel switching is rapid enough that the user perceives simultaneous sensation in both affected digits.

### C. Motion/Orientation Adaptability

The controller 102 can also operate to adapt the sensory feedback in real time to changes in the orientation or motion of the distal extremity. By modifying the sensory feedback signal in real time to adapt to the orientation change, the controller 102 ensures that the sensory feedback remains consistent and anatomically congruent, providing an accurate reflection of the user's interaction with the digital object, regardless of the orientation or movement of the distal extremity (e.g., hand).

For example, wrist motion, including wrist flexion/extension, wrist supination/pronation, and/or wrist abduction/adduction, can change the proximity of the electrodes 109 to the underlying nerves. This can change the perceived location and/or intensity of the intended sensation.

By determining an amount of a specified orientation change of the distal extremity, the controller 102 can then implement a correction to one or more pulse parameters (typically pulse amplitude) and/or to the electrode location. The electrodes are not typically intended to be moved during use, but if the position correction is significant enough that another subset of electrodes is determined to be in a more suitable position for eliciting the desired sensation, the subset of activated electrodes can be changed accordingly.

The amount of orientation change can be determined using the sensor signals discussed above. For example, EMG signals and/or motion capture data can be utilized to determine orientation change within one or more predefined movements (e.g., to determine percent flexion of the wrist).

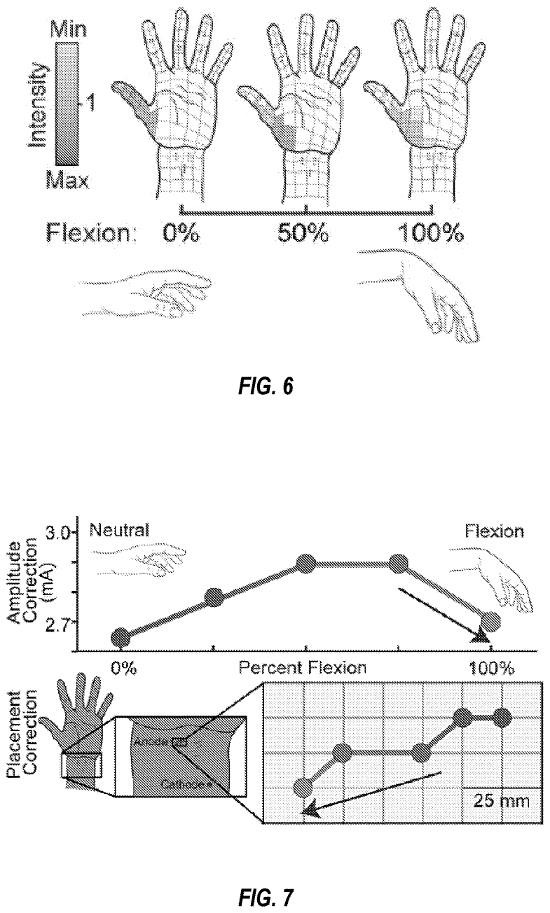

FIG. 6 is an example showing how wrist flexion (from 0% to 100%) can change the perceived intensity of sensory feedback and can also slightly affect perceived location of the sensation. FIG. 7 illustrates an example amplitude correction and an electrode placement correction that can be implemented to maintain a substantially consistent sensation during wrist motion. In use, the controller 102 can correct the current amplitude and, if needed, switch to a different subset of electrodes, to minimize perceived sensation changes caused by the wrist flexion.

While these examples are specific for wrist flexion, similar correction factors can be determined for other wrist movements, such as supination/pronation, wrist abduction/adduction, and/or more complex combination wrist movements. While corrections are expected to be generally suitable across users, customization can be implemented for a given user to fine-tune corrections to that user's particular wrist movements.

### IV. Extended Reality Systems

The wearable devices disclosed herein may be utilized as part of an extended reality system. For example, a wearable device can be communicatively connected to display hardware configured for displaying an extended reality environment to the user. The extended reality environment can include one or more digital objects with which the user can interact. As discussed above, the controller (and/or a connected external device) can determine motor intent of the user with respect to the one or more digital objects, and the wearable device can deliver TENS pulses configured to elicit distally referred sensations corresponding to the user's interaction with the digital object.

As used herein, the term “extended reality” is an umbrella term that includes computer-implemented realities such as augmented reality (AR), virtual reality (VR), mixed reality (MR), and holography.

For example, augmented reality (AR) is a live, direct, or indirect view of a physical, real-world environment whose elements are augmented (or supplemented) by computer-generated sensory input such as video, animations, graphics, or the like. Augmented reality utilizes a user's existing reality and adds to it via display hardware such as a headset, projector, or mobile device. For example, many mobile electronic devices, such as smartphones and tablets, can overlay digital content into the user's immediate environment through use of the device's camera feed and associated viewer. Thus, for example, a user could view the user's real-world environment through the display of a mobile electronic device while virtual objects are also being displayed on the display, thereby giving the user the sensation of having virtual objects integrated into a real-world environment. AR-enabled headsets or other devices can also be used.

Virtual reality (VR) is another subset of extended reality. In general, VR refers to computer technologies that use headsets and/or other peripheral devices to generate three-dimensional environments in which a user can create or interact with virtual images, objects, scenes, places, or characters, which can represent real-world or imaginary things. Virtual reality immerses a user in a visually virtual experience and allows the user to interact with the virtual environment. As used herein, the term “virtual reality” or “VR” is intended to include those computer-implemented realities that engage at least the user's sense of sight.

Another example of extended reality is a hybrid reality called mixed reality (MR). Mixed reality represents the merging of real and virtual worlds to produce new environments and visualizations where physical and digital objects co-exist and interact in real time. Many MR implementations place new imagery within a real space and often do so in such a way that the new imagery can interact-to an extent-with what is real in the physical world. For example, in the context of MR, a user may view a white board through an MR-enabled headset and use a digitally-produced pen (or even a capped physical pen) to write on the white board. In the physical world, no writing appears on the white board, but within the MR environment, the user's interaction with a real-world object caused a digital representation of the writing to appear on the white board. In MR systems, some synthetic content can react and/or interact with the real-world content in real time. There is not always a clean distinction between AR and MR environments.

Holography is another form of extended reality that can be compatible with disclosed embodiments. A hologram is typically a photographic projection of a light field that appears to be three dimensional and which can be seen with the naked eye.

As used herein, the terms “displays” and “display hardware” include devices that provide visual stimuli in the form of images, video, projections, holograms, or the like. Accordingly, a display can include a monitor or screen configured to produce images and/or video. A display can additionally include projectors configured to project images or video onto a surface and those configured for holography. A display can additionally include headsets or eyewear configured for virtual reality, augmented reality, and/or mixed reality.

In some embodiments, the display can be configured to provide visual representations on a headset or otherwise project visual representations in an interactive three-dimensional space. Alternatively, the visual aspects of the user's experience can be implemented using a 2D display that provides visual representations on a flat display, such as a laptop or desktop monitor, the screen of a mobile electronic device, or similar.

In addition to the sensory feedback provided by the wearable device described herein, certain extended reality systems can include hardware for providing further auditory, tactile, thermal, olfactory, and/or gustatory signals to the individual, which may be related to the individual's experience(s) and/or the information visualized in the extended reality environment.

### V. Additional Controller/External Device Details

The controller of the wearable devices disclosed herein, and/or any external devices utilized within the extended reality systems disclosed herein, can include one or more processors and computer-readable media such as computer memory stored on one or more hardware storage devices. The computer memory may store computer-executable instructions that when executed by one or more processors cause various functions to be performed, such as the acts recited herein. The terms controller and external device may also be referred to herein as “computers” or “computer systems.”

Computer-readable media can include any media that can be accessed by a general purpose or special purpose computer system. Physical computer-readable storage media includes RAM, ROM, EEPROM, optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

Controller functionality can additionally or alternatively be carried out by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and the like.

The controller and/or external devices may be interconnected to one or more other computing systems via one or more network connections. Network connections may include, but are not limited to, connections via wired or wireless Ethernet, cellular connections, or even computer to computer connections through serial, parallel, USB, or other connections. The controller and/or external devices may be included in a distributed system environment in which local and remote computer systems, which are linked (either by hardwired data links, wireless data links, or by a combination of hardwired and wireless data links) through a network, both perform tasks. In a distributed system environment, program modules may be located in both local and remote memory storage devices.

The controller and/or external devices may have input hardware and software user interfaces to facilitate user interaction. For example, the controller and/or external devices may be configured to operate with a keyboard, mouse, touchpad, touchscreen, camera, manual actuator (e.g., buttons, switches, dials) for allowing a user to input data into the controller. In addition, various software user interfaces may be available. Examples of software user interfaces include graphical user interfaces, text command line-based user interface, function key or hot key user interfaces, and the like.

### VI. Additional Terms & Definitions

As used herein, the term “real time” indicates an update or change that is fast enough to avoid noticeable delays or lag for an average adult user.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

In addition, unless otherwise indicated, numbers expressing quantities, constituents, distances, or other measurements used in the specification and claims are to be understood as optionally being modified by the term “about.” When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

The embodiments disclosed herein should be understood as comprising/including disclosed components, and may therefore include additional components not specifically described. Optionally, the embodiments disclosed herein are free of components that are not specifically described. That is, non-disclosed components may optionally be omitted from the disclosed embodiments and claims. For example, any wearable device controller functions and/or any wearable device structural components that are not specifically described herein may optionally be omitted.

1. A wearable device for providing sensory feedback to a user in an extended reality environment, the device comprising:
a band configured to at least partially enclose an anatomical location adjacent to a distal extremity, the band including an inner surface;
a plurality of electrodes disposed on the inner surface, the plurality of electrodes disposed so as to contact a skin surface of the anatomical location when the wearable band is positioned thereon, the plurality of electrodes being configured to deliver transcutaneous electrical nerve stimulation (TENS) to the distal extremity; and
a controller configured to
receive sensor signals indicative of movement of the distal extremity,
determine, based on the received sensor signals, a motor intent of the user with respect to a digital object within the extended reality environment,
generate, based on the determined motor intent, a sensory feedback signal to control delivery of TENS pulses through a subset of the plurality of electrodes, thereby eliciting distally referred sensations at the distal extremity and away from the band, the distally referred sensations corresponding to the user's interaction with the digital object.

2. The wearable device of claim 1, wherein the band is configured to be worn on the wrist or ankle, and wherein distal extremity is a hand or foot, respectively.

3. The wearable device of claim 2, wherein the band is formed as a bracelet or wristwatch.

4. The wearable device of claim 3, wherein the electrodes are configured to stimulate the median, ulnar, and radial nerves at the wrist of the user.

5. The wearable device of claim 3, wherein the device does not contact or impede the hand such that the hand is free to interact with real objects while wearing and operating the wearable device.

6. The wearable device of claim 2, wherein the sensory feedback signal causes TENS pulses that elicit distally referred sensations at a specific digit or subset of digits.

7. The wearable device of claim 1, wherein the sensor signals indicative of movement of the distal extremity comprise electromyography (EMG) signals and/or motion sensor signals.

8. The wearable device of claim 1, wherein the controller is further configured to modulate the sensory feedback signal to vary a magnitude of perceived sensation by modulating one or more of pulse width, pulse amplitude, or pulse frequency of the TENS pulses.

9. The wearable device of claim 1, further comprising a multiplexor communicatively coupled to the controller, the multiplexor being configured to select the subset of the plurality of electrodes and assign cathode, anode, and ground electrodes.

10. The wearable device of claim 9, wherein the controller is further configured to cause the multiplexor to steer current to different subsets of electrodes to vary localization of the distally referred sensations.

11. The wearable device of claim 1, wherein the controller is further configured to determine a distal extremity orientation change and to modify the sensory feedback signal in real time to adapt to the orientation change.

12. The wearable device of claim 11, wherein the distal extremity is a hand and wherein the orientation change includes a change in wrist flexion/extension, wrist supination/pronation, and/or wrist abduction/adduction.

13. The wearable device of claim 11, wherein the modified sensory feedback signal modulates the amplitude of the delivered TENS pulses.

14. The wearable device of claim 1, wherein the motor intent of the user is determined using a motor intent classifier trained to (1) classify distal extremity interaction with the digital object and (2) regress action progression.

15. The wearable device of claim 14, wherein the motor intent classifier is trained to classify distal extremity interaction with the digital object using a convolutional neural network, and uses a recursive Bayesian filter, such as a Kalman filter, to regress action progression.

16. The wearable device of claim 1, wherein the plurality of electrodes comprises at least 8 electrodes.

17. The wearable device of claim 1, wherein the controller is configured to provide current-controlled, biphasic TENS pulses.

18. The wearable device of claim 17, wherein the device provides a stimulation current in a range of about 1 mA to about 20 mA.

19. The wearable device of claim 1, further comprising a voltage amplifier for amplifying the TENS pulses sufficiently to pass current through the user's skin.

20. The wearable device of claim 1, wherein the extended reality environment is a virtual reality environment, a mixed reality environment, or an augmented reality environment.

21. The wearable device of claim 1, further comprising a wireless communications module for wirelessly connecting to one or more external devices.

22. An extended reality system, comprising:
a wearable device as in any preceding claim; and
display hardware communicatively connectable to the wearable device and configured for displaying an extended reality environment to the user,
wherein the extended reality environment includes one or more digital objects with which the user can interact,
wherein the determined motor intent of the user comprises determined interactions with the one or more digital objects, and
wherein the TENS pulses are configured to elicit distally referred sensations corresponding to the user's interaction with the digital object.

23. A method for providing sensory feedback to a user in an extended reality environment, the method optionally carried out using an extended reality system as in claim 22, the method comprising:
displaying an extended reality environment to a user;
determining a motor intent of the user with respect to a digital object within the extended reality environment;
delivering, by way of a wearable device, TENS pulses to elicit distally referred sensations at a distal extremity of the user, the distally referred sensations corresponding to the user's interaction with the digital object.
